(19) United States
(12) Patent Application Publication
(10) Pub. No.: US 2004/0234200 A1
(43) Pub. Date: Nov. 25, 2004

(54) Apparatus and method for non-linear thermal compensation of optical waveguide gratings

(76) Inventors: Robert M. Jennings, Austin, TX (US); Gordon Wiegand, Austin, TX (US)

Correspondence Address: 3M INNOVATIVE PROPERTIES COMPANY, PO BOX 33427, ST. PAUL, MN, 55133-3427, US

(21) Appl. No.: 10/442,603

(22) Filed: May 21, 2003

(51) Int. Cl. G02B 6/34

(52) U.S. Cl. 385/37

(57) ABSTRACT

An apparatus and method for thermal compensation of an optical waveguide grating includes a temperature compensating package attached to the optical waveguide at two attachment points encompassing the grating. The distance between the two attachment points varies non-linearly with temperature over an operating temperature range for the apparatus.

### FIELD

This invention generally relates to optical waveguide diffraction gratings. More particularly, this invention relates to apparatuses and methods for compensating for thermally induced changes in the reflected wavelength of optical waveguide diffraction gratings.

### BACKGROUND

An optical filter may be placed in a selected region of an optical fiber device to reflect a particular wavelength of incident light. One such filtering device is the Bragg grating, in which a diffraction grating is impressed into the core of an optical fiber. A conventional Bragg grating comprises an optical fiber in which the index of refraction undergoes periodic perturbations along its length. The refractive index perturbations create a diffraction grating that reflects a known spectrum of light from an incident spectrum while allowing the rest of the incident spectrum to pass unaltered. The reflected wavelength of light is centered around a wavelength equal to twice the spacing between successive perturbations multiplied by the refractive index of the fiber core. Such Bragg gratings are employed in a variety of applications including signal filtration, laser source stabilization in Dense Wavelength Division Multiplexing (DWDM) networks, reflection of fiber amplifier pump energy, compensation for chromatic dispersion of the fiber, and strain and temperature measurement, to name a few.

These applications demand very tight tolerances on the bandwidth and stability of the reflected signal over wide temperature ranges. As more communications wavelengths are crowded into single fibers, performance demands of fiber Bragg gratings (FBGs) will continue to increase.

Unfortunately, both the refractive index of the grating and the distance between successive perturbations of the grating are temperature dependent. As a result, the spectrum of light reflected by the grating is also temperature dependent. In many cases, however, it is desirable to provide a stabilized wavelength reflection spectrum that is substantially temperature independent. Shifts in the reflected wavelength reflection spectrum that occur over the operating temperature range of the FBG device are typically an order of magnitude larger than the desired tolerances for current applications. Therefore, specialized packaging of the grating is needed to compensate for the thermally induced material changes, and thereby maintain a spectrum output that is constant with changes in temperature.

One method of reducing the influence of temperature variations is to apply an axial strain on the grating that changes with temperature. Axial strain also causes shifts in the reflected spectrum, and application of the appropriate strain with temperature will effectively cancel the wavelength drift caused by optical fiber material changes, thus stabilizing the grating.

The amount of strain needed to compensate a FBG is determined using the equation:

Δλ=λ₀(ζ+α_{f})(T−T₀)+λ₀(1−Pₑ)ε (1)

where Δλ is the change in reflected wavelength, λ, of the FBG at temperature T; λ₀ is the reflected wavelength of the unstrained FBG at reference temperature T₀; and ε is the amount of axial strain imposed on the FBG by the package at applied temperature T. The terms α_{f}, ζ and Pₑ are the thermal expansion coefficient, thermo-optic coefficient, and strain optic coefficient, respectively, of the FBG.

The strain required to compensate a FBG is determined by setting αλ to 0 in equation (1) then solving for the strain as follows:

$$ϵ = - \frac{( ζ + {α}_{f} )}{( 1 - {P}_{e} )} ( T - {T}_{0} ) \qquad ( 2 )$$

The FBG properties α, ζ and Pₑ are typically treated as being temperature independent. Commonly assigned values are α=0.55 ppm/° C., ζ=6.7 ppm/° C. and Pₑ=0.22. (The term ppm is commonly used to indicate parts per million or ×10⁻⁶.) Using equation (2) and the commonly assigned FBG parameters, it is apparent that the strain applied by the package on the grating (ε_{applied}) must change with temperature by a rate of −9.3 ppm/° C. In other words, the package must impose an effective thermal expansion on the FBG of −9.3 ppm/° C. The negative value of ε_{applied} indicates that the package must cause the FBG to become shorter as temperature increases.

Current devices and methods used to thermally compensate gratings are based on either attaching the FBG to materials with negative thermal expansion coefficients (e.g. zirconia tungstate or β-eucryptite) or attaching the FBG to a package composed of two or more materials with different thermal expansion coefficients arranged in a particular design to impose the appropriate effective thermal expansion on the FBG. These devices and methods provide linear compensation to the FBG in that they produce negative effective thermal expansion coefficients that are constant or nearly constant over the temperature range of the device.

However, contrary to the typical assumption in the design of thermal compensating FBG devices, the FBG properties α, ζ and Pₑ are not constant with temperature. Therefore, the reflected wavelength of the FBG changes with temperature in a slightly non-linear fashion. Thus, when an FBG is mounted in a perfectly tuned linear package, the reflected wavelength will still change slightly (i.e., drift) with temperature. The thermally induced wavelength drift can produce changes in the reflected wavelength on the order of 0.02 nm to 0.08 nm, which is significant when compared to the application tolerances for these devices. A need exists for thermal compensating devices employing non-linear effects to effectively reduce or eliminate the thermal component of the wavelength drift, thereby improving the accuracy of the devices and greatly opening tolerances on manufacturing specifications for the devices.

### SUMMARY

Aspects of the invention described herein include apparatuses and methods that compensates for thermally induced non-linear and linear changes in the reflected wavelength of optical waveguide gratings, such as fiber Bragg gratings (FBGs).

In one aspect, an embodiment according to the invention includes a temperature compensating package attached to an optical waveguide having a grating. The temperature compensating package is attached to the optical waveguide at two attachment points encompassing the grating. The distance between the two attachment points varies non-linearly with temperature over an operating temperature range of the device.

In another aspect, an embodiment according to the invention includes a temperature compensating package having two attachment points configured for attachment to an optical waveguide. The operating temperature range of the device is divided into a plurality of segments. The distance between the attachment points varies linearly with temperature within each of the plurality of temperature range segments. The linear variations with temperature are different within each temperature range segment, such that the distance between the attachment points varies non-linearly across the operating temperature range of the device.

In another aspect, an embodiment according to the invention includes a temperature compensating package having an asymmetric layered composite substrate. The asymmetric layered composite substrate is composed of two or more materials with different coefficients of thermal expansion arranged asymmetrically about a neutral axis of the substrate, causing the substrate to bend towards the optical waveguide when heated.

In another aspect, an embodiment according to the invention includes a compression member attached to the optical waveguide. The compression member is positioned within a frame. The compression member and frame have different coefficients of thermal expansion, such that compression of the optical waveguide attached to the compression member varies non-linearly with temperature.

In another aspect, an embodiment according to the invention includes an optical fiber equipped with a Bragg grating having a characteristic wavelength, λ, in the unstressed state that is about equal to

λ₀[1+β(T−T₀)+γ(T−T₀)²]

where λ₀ is the characteristic wavelength of the grating at reference temperature, T₀, T is the applied temperature, β is the first-order thermo-optic optic coefficient of the fiber and γ is the second-order thermo-optic optic coefficient of the fiber; and a temperature compensating package attached to the fiber at two attachment points encompassing the grating, where the distance between the two attachment points, L_{g}, varies non-linearly with temperature and is about equal to

$${L}_{g0} [ 1 + \frac{( {λ}_{1} - {λ}_{0} )}{{λ}_{0} ( 1 - {P}_{e} )} + ( {α}_{f} - \frac{β}{( 1 - {P}_{e} )} ) ( T - {T}_{0} ) - \frac{γ}{( 1 - {P}_{e} )} {( T - {T}_{0} )}^{2} ]$$

where L_{g0} is the distance between the attachment points at the reference temperature, λ₁ is the wavelength of the Bragg grating at the reference temperature T₀ when attached to the package, α_{f} is the coefficient of thermal expansion of the fiber, and Pₑ is the strain optic coefficient of the fiber.

In another aspect, an embodiment according to the invention includes a temperature compensating package having two attachment points configured for attachment to the optical fiber, wherein the distance between the attachment points varies linearly with temperature within each of at least two temperature ranges, and wherein the linear variation of the distance with temperature is different for each of the at least two temperature ranges to substantially compensate for non-linear temperature behavior of the optical fiber.

In another aspect, an embodiment according to the invention includes an apparatus for temperature compensation of a region of an optical fiber with a frame having a first end and a second end; a longitudinal compression member for axially compressing the optical fiber, the compression member positioned within the frame and extending from the first end of the frame toward the second end of the frame, wherein the compression member has a coefficient of thermal expansion larger than a coefficient of thermal expansion of the frame.

In another aspect, an embodiment according to the invention includes a method for thermal compensation of an optical waveguide grating comprising securing an optical waveguide equipped with an optical grating at two attachment points of a thermal compensation package; and varying the distance between the attachment points non-linearly with temperature over an operating temperature range.

### BRIEF DESCRIPTION OF THE DRAWINGS

FIG. 1 is one embodiment according to invention of an asymmetric layered composite substrate package for non-linear thermal compensation of optical waveguide gratings.

FIG. 2 is one embodiment according to the invention of a support beam compression package for non-linear thermal compensation of optical waveguide gratings.

FIG. 3 is another embodiment according to the invention of a support beam compression package for non-linear thermal compensation of optical waveguide gratings.

FIG. 4 is another embodiment according to the invention of a support beam compression package for non-linear thermal compensation of optical waveguide gratings.

FIG. 5 is another embodiment according to the invention of a support beam compression package for non-linear thermal compensation of optical waveguide gratings.

FIG. 6 is an embodiment according to the invention of a non-linear retrofit device for converting linear thermal compensation packages to non-linear thermal compensation packages.

FIG. 7A is an exemplary embodiment of a linear thermal compensation package.

FIG. 7B is an illustration of the non-linear retrofit device of FIG. 6 incorporated into the linear thermal compensation device of FIG. 7A.

FIG. 8 is one embodiment according to invention of a fiber composite substrate package for non-linear thermal compensation of optical waveguide gratings.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

FBG properties are not constant with temperature. Thus, the effective thermal expansion α_{effective} imposed on an FBG must not only be negative but must also change with temperature. In most applications, it is necessary for the effective CTE to decrease (become more negative) with increasing temperature. However, in other applications it is necessary for the effective CTE to increase with increasing temperature instead.

Some embodiments of thermal compensation devices according to the present invention (referred to as continuous non-linear compensation devices) impart a continuously changing effective thermal expansion. The effective thermal expansion required to compensate a FBG with this approach can be estimated using the following relation:

$${α}_{effective} = - \frac{β}{( 1 - {P}_{e} )} - \frac{2 γ}{( 1 - {P}_{e} )} ( T - {T}_{0} ) \qquad ( 3 )$$

where β and γ are experimentally determined first and second order parameters describing the change in reflected wavelength of an unstrained FBG with temperature as follows:

Δλ=λ₀[β(T−T₀)+γ(T−T₀)²] (4)

Additional higher order terms may also be added to equations (3) and (4) for even further accuracy. It should be noted that the coefficients β and γ are properties of the fiber and not the grating, while λ₀ is a characteristic of the grating.

Experimental measurements of FBGs in a non-commercial, high numerical aperture germano-silicate photosensitive fiber (designated TF-19), manufactured by 3M Company, of Saint Paul, Minn., U.S.A., yield exemplary values of β and γ to be 6.61±0.18 ppm/° C. and 5.3±1.7 ppb/° C.², respectively, for 18 mm long FBGs with room temperature reflected wavelengths written at 1555 nm (ppb indicates parts per billion or ×10⁻⁹). The experimentally measured values are representative of most commercially available optical fibers in this wavelength range. The experimentally measured values mean that a compensating device based on this approach must impose effective thermal expansions on FBGs around −8.5 ppm/° C. at room temperature, and change at a rate of −13.6 ppb/° C.² with increasing temperature to be useful in compensating both linear and non-linear temperature sensitivities in FBGs written in this fiber.

Embodiments of thermal compensation devices according to the present invention based on a continuous non-linear approach employ several different non-linear mechanical effects, such as changes in material properties with temperature, Hertzian contact, and/or geometric non-linearities.

Other embodiments of thermal compensation devices according to the present invention (referred to as multi-linear compensation devices) impose constant effective thermal expansions on FBGs over incremental temperature ranges within the overall temperature range of the device, but change from one incremental range to another as temperature changes. An exemplary bi-linear device would impose an effective thermal expansion on the FBG that could be described with the following equation:

$${α}_{effective} = \{ \begin{matrix}- \frac{{β}_{1}}{( 1 - {P}_{e} )} for T \leq {T}_{a} \\ - \frac{{β}_{2}}{( 1 - {P}_{e} )} for T \geq {T}_{a}\end{matrix} \qquad ( 5 )$$

where β₁ and β₂ are experimentally determined parameters describing the linear change in reflected wavelength above and below a particular temperature, Tₐ as follows:

$$λ = \{ \begin{matrix}{λ}_{0} [ 1 + {β}_{1} ( T - {T}_{0} ) ] for T \leq {T}_{a} \\ {λ}_{0} [ 1 + {β}_{2} ( T - {T}_{0} ) ] for T \geq {T}_{a}\end{matrix} \qquad ( 6 )$$

Additional incremental temperature ranges may also be included to equations (5) and (6) for a more accurate multi-linear approach. It should be noted that the coefficients β₁ and β₂ are properties of the fiber and not the grating, while λ₀ is a characteristic of the grating.

Experimental measurements of FBGs in a non-commercial, high numerical aperture germano-silicate photosensitive fiber (designated TF-19), manufactured by 3M Company, of Saint Paul, Minn., U.S.A., yield exemplary values of β₁, β₂ and T₀ to be 6.26±0.24 ppm/° C., 6.94±0.21 ppm/° C., and 22±5° C., respectively, for 18 mm long FBGs with room temperature reflected wavelengths written at 1555 nm. The experimentally measured values are representative of most commercially available optical fibers in this wavelength range. The experimentally measured values mean that a bi-linear package must have an effective coefficient of thermal expansion of −8.0 ppm/° C. below 22° C. and −8.9 ppm/° C. above 22° C. to compensate these FBGs.

Embodiments of thermal compensation devices according to the present invention based on a multi-linear approach can employ discontinuous, non-linear mechanical effects such as contact and buckling.

In accordance with the present invention, the characteristic wavelength λ of a fiber grating can be described with respect to temperature and applied strain as follows:

λ=λ₀[1+β(T−T₀)+γ(T−T₀)²]+λ₀(1−Pₑ)ε (7)

where:

T₀ is the reference temperature;

T is the applied temperature;

ε is the applied strain;

λ₀ is the characteristic wavelength measured at the reference temperature under zero stress;

β is the 1st order thermo-optic optic coefficient of the unstressed wavelength versus temperature behavior;

γ is the 2nd order thermo-optic optic coefficient of the unstressed wavelength versus temperature behavior; and

Pₑ is the strain optic coefficient of the fiber.

The coefficients β, γ and Pₑ are properties of the fiber. This analysis differs from most in that the second order term γ is included, and that the coefficients β and γ include both thermal expansion and refractive index effects on the wavelength shift.

The applied strain is:

$$ϵ = \frac{{L}_{g}}{{L}_{g0}} - 1 - {α}_{f} ( T - {T}_{0} ) \qquad ( 8 )$$

where:

L_{g0} is the unstressed grating length measured at the reference temperature;

L_{g} is the stressed grating length measured at the applied temperature; and

α_{f} is the coefficient of thermal expansion (CTE) of the fiber.

To determine the length behavior needed to thermally compensate a fiber grating, equation (8) is substituted into equation (7) and solved for L_{g} as follows:

$${L}_{g} = {L}_{g0} [ 1 + \frac{( {λ}_{1} - {λ}_{0} )}{{λ}_{0} ( 1 - {P}_{e} )} + ( {α}_{f} - \frac{β}{( 1 - {P}_{e} )} ) ( T - {T}_{0} ) - \frac{γ}{( 1 - {P}_{e} )} {( T - {T}_{0} )}^{2} ] \qquad ( 9 )$$

where λ₁ is the stressed wavelength of the grating at the reference temperature (i.e., the wavelength of the grating when attached to the thermal compensation package at the reference temperature).

Asymmetric Layered Composite Substrate Package

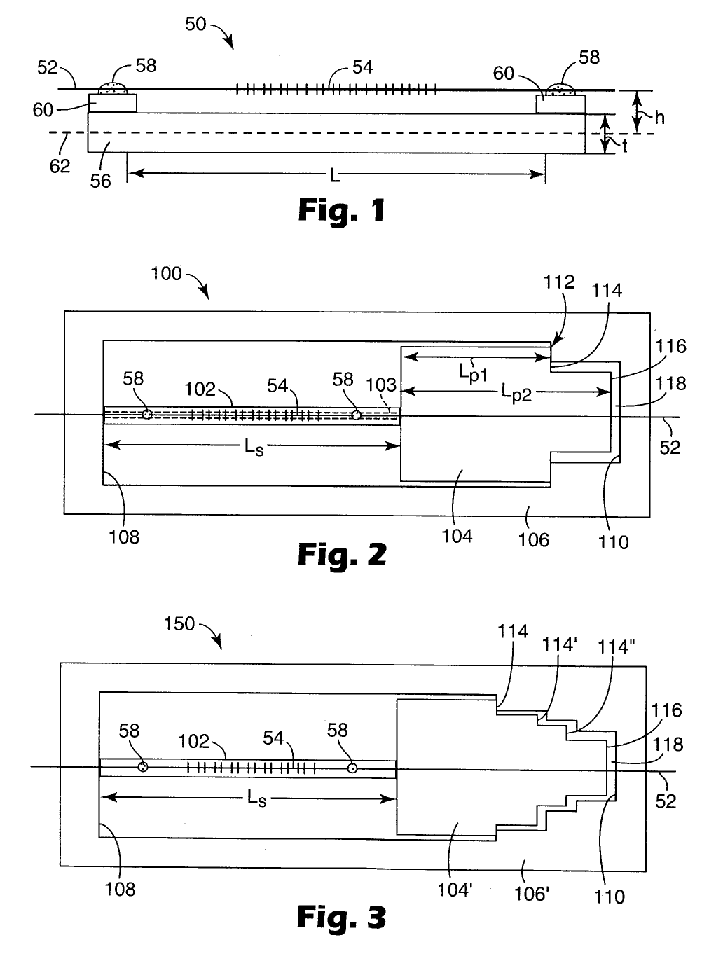

A simple non-linear thermal compensation device 50 can be made for an FBG comprising an optical fiber 52 equipped with a fiber Bragg grating (FBG) 54 by attaching the fiber 52 and FBG 54 to an asymmetric layered composite substrate 56 as shown in FIG. 1. The asymmetric layered composite substrate 56 is composed of two or more materials with different coefficients of thermal expansion arranged in an asymmetric manner about neutral axis 62 so as to cause the substrate 56 to bend towards the FBG 54 when heated. When this occurs the length L of the FBG 54 between the bonding points 58 decreases, thus providing an effective negative thermal expansion as required for thermal compensation of the FBG 54. The posts 60 located between the fiber 52 and the asymmetric layered composite substrate 56 hold the fiber a distance above the substrate and serve to amplify the strain effect imposed by the device on the FBG 54. As used herein, the neutral axis is the line or plane in a member under transverse pressure, at which the member is neither stretched nor compressed (i.e., where the longitudinal stress is zero).

Under certain circumstances the effective thermal expansion imposed by the asymmetric layered composite substrate 56 on the FBG 54 changes with temperature to a degree that it can be useful for compensating the linear and non-linear changes in FBG reflected wavelengths with temperature.

For an asymmetric layered composite substrate package with posts, the length of the FBG 54 between the posts 60 at any temperature will be:

$${L}_{g} = 2 ( \frac{1}{κ} - h ) sin ( \frac{1}{2} κ L ) \qquad ( 10 )$$

where:

κ is the curvature of the bimetallic substrate (e.g., 1/radius of curvature);

L is the length of the substrate as measured along the curved neutral axis of the substrate; and

h is the distance between the fiber and the neutral axis 62 of the substrate at the attachment points.

The parameters, κ, L and h will change with temperature as follows:

$$\begin{matrix}L = {L}_{0} [ 1 + {α}_{L} ( T - {T}_{0} ) ] \\ h = {h}_{0} [ 1 + {α}_{h} ( T - {T}_{0} ) ] \\ κ = {κ}_{0} + \frac{f}{t} ( T - {T}_{0} ) = {κ}_{0} + F ( T - {T}_{0} )\end{matrix} \qquad ( 11 )$$

where:

L₀ is the substrate length measured at the reference temperature;

h₀ is the fiber to neutral axis distance measured at the reference temperature;

κ₀ is the substrate curvature measured at the reference temperature;

α_{L} is the CTE of the substrate along the neutral axis;

αₕ is the effective CTE of the combined materials between the substrate neutral axis and fiber;

t is the thickness of the substrate;

ƒ is the change in substrate curvature with temperature, or “flexivity” of the substrate.

In equation (11), the term

$$\frac{f}{t}$$

is replaced with F to simplify the analysis.

Usually the material properties α_{L}, αₕ and ƒ are constant with temperature but in some cases ƒ may vary slightly with temperature over a desired operating range. This variation of ƒ has an impact on the thermal compensation package design.

An asymmetric layered composite substrate thermal compensation package according to the invention is designed by first measuring the fiber properties and determining the required grating length. Next, for the grating length needed, the available bimetallic materials are determined. A combination of equations (9), (10) and (11) is used to determine the required values of h and t to thermally compensate the fiber.

In some embodiments according to the invention, additional design limitations are put in place to ensure a reasonable manufacturing yield. Specifically, h is required to be greater than ½ t to ensure the fiber sits above the top surface of the bimetallic material. When using some bimetallic materials, it is possible for h to be less than ½ t. In this embodiment according to the invention, a groove is required in the bimetallic material substrate to accommodate the fiber (rather than securing the fiber to posts extending above the bimetallic material substrate).

A more direct but less accurate calculation of thermal compensation package parameters may be determined by using the approximation:

$$sin ( x ) \approx x - \frac{1}{6} {x}^{3} \qquad ( 12 )$$

in equation (10). Most analysis of bimetallic material substrates use the approximation sin(x)=x and thus do not recognize the nonlinear capabilities of this device. Substituting equation (12) into equation (10):

$${L}_{g} = L ( 1 - κ h ) ( 1 - \frac{1}{24} {κ}^{2} {L}^{2} ) \qquad ( 13 )$$

Setting κ₀=0 (e.g., the reference temperature is the temperature at which the bimetallic substrate is flat) and substituting equation (11) directly into equation (13):

$${L}_{g} = {L}_{0} [ 1 + ( {α}_{L} + {h}_{0} F ) ( T - {T}_{0} ) - ( {h}_{0} F ( {α}_{L} + {α}_{h} ) + \frac{1}{24} {L}_{0}^{2} {F}^{2} ) {( T - {T}_{0} )}^{2} + O [ {( T - {T}_{0} )}^{3} ] \qquad ( 14 )$$

where O[(T−T₀)³] represents all of the terms containing (T−T₀)³ and higher order. These terms will be small and can be neglected.

Setting equation (14) for the thermal compensation package equal to equation (9) for the fiber, and grouping all terms with respect to (T−T₀)ⁱ to separate out the different package parameters:

$$\begin{matrix}{L}_{0} = {L}_{g0} [ 1 + \frac{( {λ}_{1} - {λ}_{0} )}{{λ}_{0} ( 1 - {P}_{e} )} ] \\ {L}_{0} ( {α}_{L} + {h}_{0} F ) = {L}_{g0} ( {α}_{f} - \frac{β}{( 1 - {P}_{e} )} ) \\ {L}_{0} [ {h}_{0} F ( {α}_{L} + {α}_{h} ) + \frac{1}{24} {L}_{0}^{2} {F}^{2} ] = {L}_{g0} \frac{γ}{( 1 - {P}_{e} )}\end{matrix} \qquad ( 15 )$$

Solving for L₀, h₀ and F:

$$\begin{matrix} {L}_{0} = {L}_{g0} [ 1 + \frac{( {λ}_{1} - {λ}_{0} )}{{λ}_{0} ( 1 - {P}_{e} )} ] \\ F = \frac{f}{t} = \sqrt{\frac{24}{{L}_{0}^{2}} [ \frac{{L}_{g0}}{{L}_{0}} \frac{γ}{( 1 - {P}_{e} )} + ( {α}_{L} + {α}_{h} ) ( \frac{{L}_{g0}}{{L}_{0}} ( {α}_{f} - \frac{β}{( 1 - {P}_{e} )} ) - {α}_{L} ) ]} \\ {h}_{0} = \frac{1}{F} [ {α}_{L} - \frac{{L}_{g0}}{{L}_{0}} ( {α}_{f} - \frac{β}{( 1 - {P}_{e} )} ) ]\end{matrix} \qquad ( 16 )$$

The assumptions used to arrive at equations (16) are: 1) the curvature, κ, is zero at the reference temperature T₀; and 2) all the material properties are constant with respect to temperature.

Support Beam Compression Package

Another exemplary embodiment of a non-linear thermal compensation device 100 is shown in FIG. 2. This embodiment provides a bilinear FBG thermal compensation. The thermal compensation device 100 consists of a slender or small diameter support beam 102 and a larger diameter plunger 104 fitted inside a rigid frame 106. The plunger 104 is made from a material with a high coefficient of thermal expansion (CTE) while the frame 106 is made from a material with a low CTE. In one embodiment according to the invention, the support beam 102 may be made out of materials with a range of CTEs equal to or less than the CTE of the plunger 104 material. However, lower CTE materials are preferred. The diameter of the support beam 102 is of sufficient diameter and rigidity to prevent buckling under compressive axial loading.

When the thermal compensation package is heated, the support beam 102 and plunger 104 expand at a greater rate than the frame 106 and eventually start pushing on the ends 108, 110 of the frame 106. As the support beam 102 and plunger 104 push on the frame 106, an axial compressive force is generated within the support beam 102 and plunger 104. The average compressive forces in the support beam 102 and plunger 104 are equal. However, the smaller diameter of the support beam 102 relative to the diameter of the plunger 104 produces a higher compressive stress (force per unit area) in the support beam 102 than in the plunger 104. The higher compressive stress translates into a higher compressive strain in the support beam 102. If the compressive strain is large enough, the compressive strain will overcome the thermal expansion of the support beam 102, thus forcing the support beam 102 to become shorter as the temperature increases. If an FBG 54 is mounted on the support beam 102, an effective negative CTE is imposed on the FBG 54. If the frame 106 and plunger 104 are infinitely rigid compared to the support beam 102, then the effective thermal expansion imposed on the support beam 102 can be estimated using the following equation:

$${α}_{effective} = {α}_{fr} + \frac{{L}_{p}}{{L}_{s}} ( {α}_{fr} - {α}_{p} ) \qquad ( 17 )$$

where:

Lₛ is the length of the support beam;

Lₚ is the length of the plunger (Note: Lₚ₁ is the length when T≦Tₐ and Lₚ₂ is the length when T≧Tₐ);

α_{fr} is the CTE of the frame;

αₚ is the CTE of the plunger.

The thermal compensation package 100 is made non-linear by creating a “stepped contact” interface 112 between the plunger 104 and frame 106. At low temperatures, the plunger 104 and frame 106 come into contact at an intermediate step position 114 giving the plunger 104 an effective length of L_{plunger(low)} as shown in FIG. 2. As the package 100 is heated, the end 116 of the plunger 104 will continue to expand until it comes into contact with the end 110 of the frame 106, increasing the length of the plunger 104 to L_{plunger(high)}. As can be seen from equation (17), if the plunger 104 has a higher CTE than the frame 106, then increasing the plunger 104 length will cause the effective CTE imposed on the support beam 102 to become more negative. The temperature at which the transition occurs will be dictated by the thickness of the gap 118 between the end 116 of the plunger 104 and end 110 of the frame 106.

The thermal compensation package of FIG. 2 can be assembled by cooling the support beam 102 and plunger 104 and/or heating the frame 106 until the support beam 102 and plunger 104 fit inside the frame 106. The entire assembly will hold itself together at room temperature by the compressive forces created in the support beam 102 and plunger 104. The temperature at which the device can be assembled is dictated by the difference in length between the frame 106 measured to the step 114 and the length of the support beam 102 plus the length of the plunger 106. Tuning of the assembly and transition temperatures could be achieved by the appropriate positioning of a set screw (not shown) or other means of adjusting the gap 118 thickness. The effective CTE of the device 100 would be set by the relative lengths of the various components in the device. The FBG 54 can be mounted to the support beam 102 either at two points on either side of the grating 54 or continuously along the grating 54. In one embodiment according to the invention, the support beam 102 has an axial bore 103 (illustrated by dashed lines in FIG. 2) in which the FBG 54 is secured. Such a configuration would be beneficial in protecting the FBG from the environment.

Another embodiment of a non-linear thermal compensation package 150 according to the invention is shown in FIG. 3. The thermal compensation package 150 of FIG. 3 provides multi-linear thermal compensation by incorporating additional steps 114′, 114″ between the plunger 104′ and frame 106′, in contrast to the bilinear device of FIG. 2. The effective CTE of the thermal compensation package 150 of FIG. 3 is determined in the same manner described above with respect to the bilinear device 100 of FIG. 2.

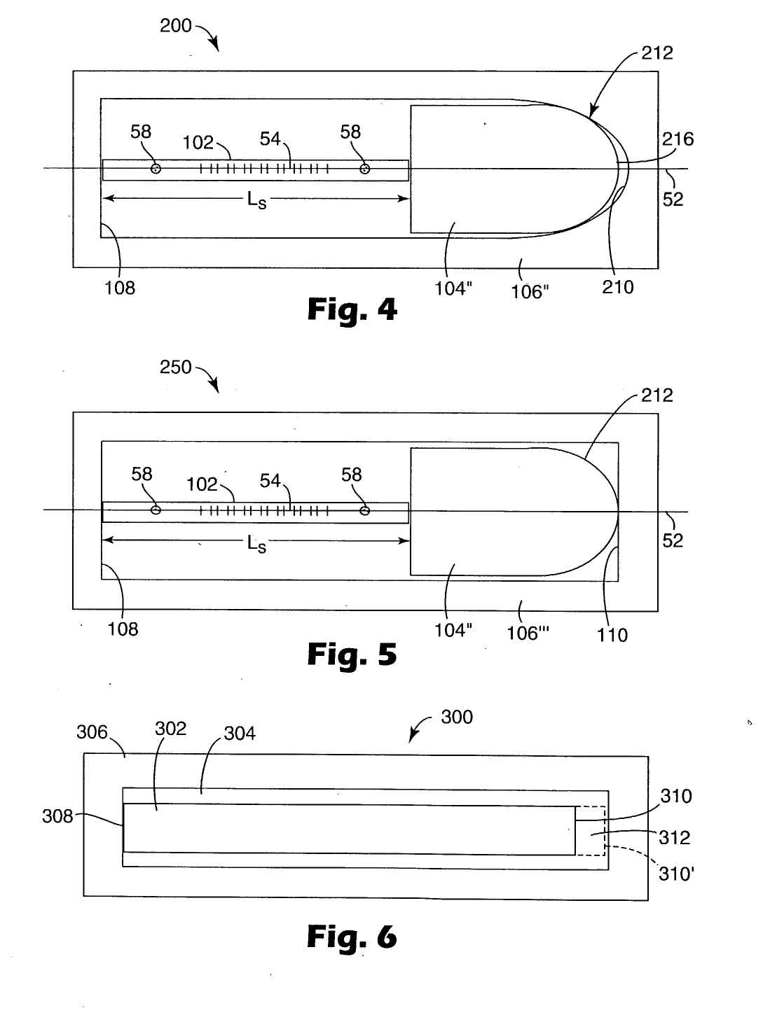

Yet another embodiment of a non-linear thermal compensation package 200 according to the invention is shown in FIG. 4. The thermal compensation package 200 of FIG. 4 provides a curved interface 212 between the end 216 of the plunger 104″ and the end 210 of frame 106″. The curved interface 212 allows a continuous length change, rather than a stepped length change as provided in the embodiments 100, 150 of FIGS. 2 and 3.

Yet another embodiment of a non-linear thermal compensation package 250 according to the invention is shown in FIG. 5. The thermal compensation package 250 of FIG. 5 includes a curved end 212 on the plunger 104″, and a flat end 10 on the frame 106′″. This thermal compensation package 250 functions differently from the previously illustrated embodiments 100, 150, 200 in that the non-linearity results from the force-displacement relationship from Hertzian contact problems. As the plunger 104″ is pushed harder into the frame 106, the contact area between the plunger 104″ and frame 106 increases and the contact stiffness increases. This means that increasingly larger forces are required to push the plunger 104″ further into the frame 106, and the axial compressive force on the plunger 104″ and support beam 102 increases with temperature in a non-linear manner.

Bilinear Retrofit Device

Linear thermal compensation packages may be converted to bilinear thermal compensation packages by incorporation of a retrofit device, as shown in FIG. 6. The retrofit device 300 consists of a beam 302 that fits inside the cavity 304 of an outer frame 306. The beam 302 and the frame 306 are composed of different materials with different coefficients of thermal expansion (CTE's). The length of the beam 302 is selected so that over part of the operating temperature range of the device 300, the beam 302 is shorter than the length of the cavity 304. As indicated at 308, one end of the beam 302 is attached to one end of the cavity 304 inside the frame 306. Depending upon the temperature, there is either a gap 312 between the free end 310 of the beam 302 and the end of the cavity 304 (as illustrated in solid lines in FIG. 6) or the free end 310 of the beam 302 and frame 306 are in compressive contact (as illustrated by dashed line 310′ in FIG. 6).

When the free end 310 of the beam 302 and frame 306 are not in contact, the effective CTE of the frame 306 (and thus device 300) will be determined solely by the CTE of the frame material. When the free end 310 of the beam 302 and frame 306 are in contact, the device 300 will display a different effective CTE that is largely determined by the CTE's, moduli and cross-sectional areas of the frame 306 and beam 302. The temperature at which contact between beam 302 and frame 306 first occurs is determined by the lengths and CTE's of the beam 302 and cavity 304. If the beam 302 is composed of a material with a lower CTE than the CTE of the frame material, then the device 300 will exhibit a step decrease in its effective CTE from the frame material CTE to the composite CTE as the temperature drops through the contact temperature. If the beam 302 is composed of a material with a higher CTE than the frame material, then the device 300 will also exhibit a step decrease in its effective CTE, but from the composite CTE to the frame material CTE as the temperature drops through the contact temperature.

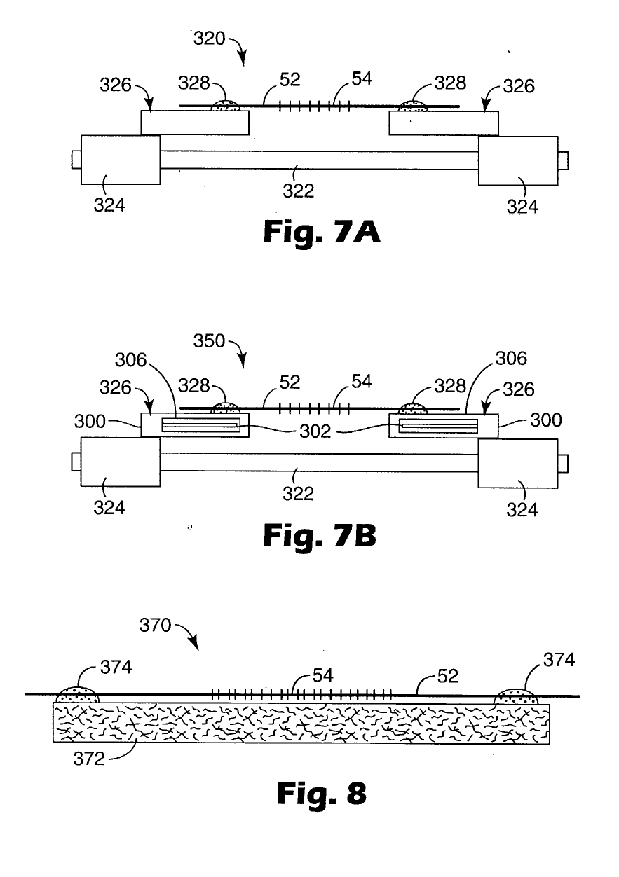

The utility of the retrofit thermal compensation device 300 of FIG. 6 is demonstrated by incorporating the retrofit device 300 into an existing linear thermal compensation device 320, as shown in FIG. 7A. The linear compensation device 320 of FIG. 7A includes a low CTE rod 322 equipped with two high CTE end caps 324 and high CTE cantilevers 326. The end caps 324 and cantilevers 326 are designed so that cantilevers 326 extend back over the rod 322. An FBG 54 is attached at bond points 328 near the ends of the two cantilevers 326 as shown in FIG. 7A. As the temperature of the package 320 is heated, the low CTE rod 322 increases in length by a small amount, while the high CTE end caps 324 and cantilevers 326 increase in length by a larger amount, thereby causing the distance between the two bond points 328 on the cantilevers 326 to decrease with increasing temperature.

The effective CTE imposed on the FBG 54 is largely a function of the lengths and CTEs of the rod 322 and cantilevers 326 and the distance between bond points 328.

FIG. 7B illustrates the incorporation of the retrofit thermal compensation device 300 of FIG. 6 into the cantilever 326 of FIG. 7A, thereby converting the linear thermal compensation package 320 of FIG. 7A to a bilinear thermal compensation package 350. In the embodiment illustrated in FIG. 7B, the retrofit device 300 consists of a high CTE outer component 306 with a low CTE inner component 302. At temperatures above the contact temperature, T₀, for the retrofit device, the cantilever 326 would have a CTE dictated by the CTE of the outer component 306. At temperatures below the contact temperature, T₀, the inner and outer components 302, 306 are in contact with each other, resulting in a lower effective CTE for the cantilever 326. Thus, the effective CTE imposed on the FBG by the thermal compensation package 350 of FIG. 7B is larger at lower temperatures.

Fiber Composite Material Package

Another embodiment of a thermal compensation device according to the invention for use in a bilinear or continuous non-linear compensation approach is illustrated in FIG. 8. The device 370 of FIG. 8 includes an optical fiber 52 equipped with a Bragg grating 54 attached to a substrate 372 at attachment points 374. Substrate 372 is comprised of a continuous fiber composite surrounded by an organic matrix. As one example, substrate 372 comprises a polymer fiber available under the name Spectra® (available from Honeywell, of Morristown, N.J., U.S.A.) in an epoxy matrix. Spectra® fiber has a CTE lower than the effective CTE typically required to thermally compensate FBGs. When the fiber is incorporated into an epoxy matrix, the CTE of the fiber/epoxy composite is raised to a value closer to what is required for FBG thermal compensation. Different types of fibers, such as carbon fiber, may optionally be added to the composite to further tune the CTE to the requirements of the FBG. If the tensile modulus of the matrix material drops rapidly (as often occurs near the glass transition temperature of epoxies), the properties of the fiber will dominate the properties of the composite along the direction parallel to the composite fiber axes, and the effective thermal expansion of the composite substrate 372 in the fiber axie direction will become lower with increasing temperature. The magnitude of the CTE change can be controlled by controlling the amount that the matrix modulus decreases with temperature and by controlling the glass transition temperature of the epoxy.

Although specific embodiments have been illustrated and described herein, upon reading and understanding of this disclosure it will be appreciated by those of ordinary skill in the art that a wide variety of alternate and/or equivalent implementations and embodiments may be substituted for the specific embodiments shown and described without departing from the scope of the present invention. Those with skill in the optical, mechanical, electro-mechanical and opto-mechanical arts will readily appreciate that the present invention may be implemented in a very wide variety of embodiments. This application is intended to cover any adaptations or variations of the embodiments discussed herein.

What is claimed is:

1. An apparatus comprising:
an optical waveguide having an optical grating; and
a temperature compensating package attached to the optical waveguide at two attachment points encompassing the grating, where the distance between the two attachment points varies non-linearly with temperature over an operating temperature range.

2. The apparatus of claim 1, wherein the temperature compensating package comprises an asymmetric layered composite substrate having a neutral axis with a curvature κ, and a length L, and wherein the attachment points hold the optical fiber a distance h from the neutral axis.

3. The apparatus of claim 1, wherein the optical waveguide is attached to the temperature compensating package continuously between the two attachment points.

4. The apparatus of claim 2, wherein the material substrate is a bimetallic material.

5. The apparatus of claim 1, wherein the temperature compensating package comprises a fiber composite substrate.

6. The apparatus of claim 1, wherein the temperature compensating package comprises a fiber composite substrate, wherein the composite fibers are substantially parallel with the optical waveguide.

7. The apparatus of claim 6, wherein the effective thermal expansion of the fiber composite substrate becomes lower with increasing temperature.

8. The apparatus of claim 1, wherein the operating temperature range is comprised of a plurality of discrete temperature ranges, and wherein the distance between the attachment points varies linearly with temperature within each of the plurality of temperature ranges, and wherein the linear variation of the distance with temperature is different for each of the plurality of temperature ranges.

9. The apparatus of claim 1, wherein the temperature compensating package comprises:
a frame having a first end and a second end;
a longitudinal compression member including the two attachment points, the compression member positioned within the frame and extending from the first end of the frame toward the second end of the frame, wherein the compression member has a coefficient of thermal expansion larger than a coefficient of thermal expansion of the frame.

10. The apparatus of claim 9, wherein at a temperature equal to or greater than a predetermined temperature T, the compression member contacts the first end and the second end of the frame.

11. The apparatus of claim 10, wherein the optical waveguide has a first effective coefficient of thermal expansion at temperatures greater than predetermined temperature T, and a second effective coefficient of thermal expansion at temperatures less than predetermined temperature T.

12. The apparatus of claim 11, wherein the first and second effective coefficients of thermal expansion are negative.

13. The apparatus of claim 11, wherein the first and second effective coefficients of thermal expansion are positive.

14. The apparatus of claim 11, wherein one of the first and second effective coefficients of thermal expansion is positive, and one of the first and second effective coefficients of thermal expansion is negative.

15. The apparatus of claim 9, wherein the compression member comprises:
a support rod for attachment to the optical fiber, a first end of the support rod in contact with a first end of the frame; and
a plunger extending from a second end of the support rod toward the second end of the frame.

16. The apparatus of claim 15, wherein the plunger has a coefficient of thermal expansion greater than a coefficient of thermal expansion of the mount.

17. The apparatus of claim 15, wherein the plunger has a coefficient of thermal expansion greater than a coefficient of thermal expansion of the frame.

18. An apparatus comprising:
an optical fiber equipped with a Bragg grating having a characteristic wavelength, λ, in the unstressed state that is about equal to
λ₀[1+β(T−T₀)+γ(T−T₀)²]
where λ₀ is the characteristic wavelength of the grating at reference temperature, T₀, T is the applied temperature, β is the first-order thermo-optic optic coefficient of the fiber and γ is the second-order thermo-optic optic coefficient of the fiber; and
a temperature compensating package attached to the fiber at two attachment points encompassing the grating, where the distance between the two attachment points, L_{g}, varies non-linearly with temperature and is about equal to
$${L}_{g0} [ 1 + \frac{( {λ}_{1} - {λ}_{0} )}{{λ}_{0} ( 1 - {P}_{e} )} + ( {α}_{f} - \frac{β}{( 1 - {P}_{e} )} ) ( T - {T}_{0} ) - \frac{γ}{( 1 - {P}_{e} )} {( T - {T}_{0} )}^{2} ]$$
where L_{g0} is the distance between the attachment points at the reference temperature, λ₁ is the wavelength of the Bragg grating at the reference temperature T₀ when attached to the package, α_{f} is the coefficient of thermal expansion of the fiber, and Pₑ is the strain optic coefficient of the fiber.

19. The apparatus of claim 18, wherein the coefficient of thermal expansion α_{f}, and the strain optic coefficient Pₑ, are substantially constant over an operating temperature range of the apparatus.

20. The apparatus of claim 18, wherein thermo-optic optic coefficients β and γ are substantially constant over an operating temperature range of the apparatus.

21. The apparatus of claim 18, wherein the temperature compensating package comprises a material substrate having a neutral axis with a curvature κ, and a length L, and wherein the attachment points hold the optical fiber a distance h from the neutral axis; wherein κ, L and h are related to each other and the optical fiber properties α_{f}, β, γ, and Pₑ through the relation
$$2 ( \frac{1}{κ} - h ) sin ( \frac{1}{2} κ L ) = {L}_{g0} [ 1 + \frac{( {λ}_{1} - {λ}_{0} )}{{λ}_{0} ( 1 - {P}_{e} )} + ( {α}_{f} - \frac{β}{( 1 - {P}_{e} )} ) ( T - {T}_{0} ) - \frac{γ}{( 1 - {P}_{e} )} {( T - {T}_{0} )}^{2} ] .$$

22. The apparatus of claim 21, wherein the material substrate has a uniform thickness t and width as measured along its length.

23. The apparatus of claim 21, wherein the material substrate comprises an asymmetric layered composite substrate.

24. The apparatus of claim 23, wherein the material substrate is a bimetallic material.

25. The apparatus of claim 21, wherein curvature κ changes as a function of temperature.

26. The apparatus of claim 21, wherein length L changes as a function of temperature.

27. The apparatus of claim 21, wherein height h changes as a function of temperature.

28. The apparatus of claim 21, wherein
$$2 ( \frac{1}{κ} - h ) sin ( \frac{1}{2} κ L ) \approx L ( 1 - κ h ) ( 1 - \frac{1}{24} {κ}^{2} {L}^{2} ) .$$

29. The apparatus of claim 22, wherein h is greater than ½ t.

30. The apparatus of claim 22, wherein h is less than ½ t.

31. The apparatus of claim 18, wherein the temperature compensating package comprises material substrate having a neutral axis with a curvature κ, and a length L, wherein the attachment points hold the optical fiber a distance h from the neutral axis and wherein
κ is about equal to F(T−T₀) at a temperature T;
L is about equal to L₀[1+α_{L}(T−T₀)] at temperature T; and
h is about equal to h₀[1+αₕ(T−T₀)] at temperature T;
where L₀ is the length of the material substrate at reference temperature T₀, h₀ is the fiber distance from the neutral axis at reference temperature T₀, F is the flexivity of the material substrate, α_{L} is the coefficient of thermal expansion of the material substrate, and αₕ is the effective coefficient of thermal expansion of materials between the fiber and neutral axis;
and wherein L₀, and h₀ are related to each other, the package properties, F, α_{L} and αₕ and the fiber properties, α_{f}, β, γ, and Pₑ through the relations
$$\begin{matrix}{L}_{0} = {L}_{g0} [ 1 + \frac{( {λ}_{1} - {λ}_{0} )}{{λ}_{0} ( 1 - {P}_{e} )} ] \\ F = \frac{f}{t} = \sqrt{\frac{24}{{L}_{0}^{2}} [ \frac{{L}_{g0}}{{L}_{0}} \frac{γ}{( 1 - {P}_{e} )} + ( {α}_{L} + {α}_{h} ) ( \frac{{L}_{g0}}{{L}_{0}} ( {α}_{f} - \frac{β}{( 1 - {P}_{e} )} ) - {α}_{L} ) ]} \\ {h}_{0} = \frac{1}{F} [ {α}_{L} - \frac{{L}_{g0}}{{L}_{0}} ( {α}_{f} - \frac{β}{( 1 - {P}_{e} )} ) ]\end{matrix}$$
where λ₁ is the wavelength of the Bragg grating at reference temperature T₀ when attached to the temperature compensating package.

32. An apparatus for temperature compensation of a region of an optical fiber, wherein the apparatus comprises:
an optical fiber equipped with a grating; and
a temperature compensating package having two attachment points configured for attachment to the optical fiber, wherein the distance between the attachment points varies linearly with temperature within each of at least two temperature ranges, and wherein the linear variation of the distance with temperature is different for each of the at least two temperature ranges to substantially compensate for non-linear temperature behavior of the optical fiber.

33. The apparatus of claim 32, wherein the at least two temperature ranges extend over an operating temperature range of the apparatus.

34. The apparatus of claim 32, wherein the optical fiber is attached to the temperature compensation package continuously between the two attachment points.

35. An apparatus for temperature compensation of a region of an optical fiber, wherein the apparatus comprises:
a frame having a first end and a second end;
a longitudinal compression member for axially compressing the optical fiber, the compression member positioned within the frame and extending from the first end of the frame toward the second end of the frame, wherein the compression member has a coefficient of thermal expansion larger than a coefficient of thermal expansion of the frame.

36. The apparatus of claim 35, wherein at a temperature equal to or greater than a predetermined temperature T, the compression member contacts the first end and the second end of the frame.

37. The apparatus of claim 36, wherein the optical fiber has a first effective coefficient of thermal expansion at temperatures greater than predetermined temperature T, and a second effective coefficient of thermal expansion at temperatures less than predetermined temperature T.

38. The apparatus of claim 37, wherein the first and second effective coefficients of thermal expansion are negative.

39. The apparatus of claim 37, wherein the first and second effective coefficients of thermal expansion are positive.

40. The apparatus of claim 35, wherein the compression member comprises:
a longitudinal mount for attachment to the optical fiber, a first end of the mount in contact with a first end of the frame; and
a plunger extending from a second end of the mount toward the second end of the frame.

41. The apparatus of claim 40, wherein at a temperature equal to or greater than a predetermined temperature T, a contact face of the plunger contacts the second end of the frame along a contact interface.

42. The apparatus of claim 41, wherein the mount axially compresses the attached optical fiber at temperatures greater than predetermined temperature T.

43. The apparatus of claim 42, wherein the mount has an effective negative coefficient of thermal expansion at temperatures greater than predetermined temperature T.

44. The apparatus of claim 41, wherein the contact interface comprises a plurality of successive incremental steps, each successive step occurring at a predetermined incremental temperature Tₙ.

45. The apparatus of claim 44, wherein a length of the plunger increases with each successive incremental step.

46. The apparatus of claim 44, wherein an effective coefficient of thermal expansion of the mount varies incrementally with each successive incremental step of the plurality of steps.

47. The apparatus of claim 41, wherein contact interface comprises a curved interface.

48. The apparatus of claim 47, wherein an effective coefficient of thermal expansion of the mount varies non-linearly with changes in temperature.

49. The apparatus of claim 40, wherein the plunger has a coefficient of thermal expansion greater than a coefficient of thermal expansion of the mount.

50. The apparatus of claim 40, wherein the plunger has a coefficient of thermal expansion greater than a coefficient of thermal expansion of the frame.

51. The apparatus of claim 35, wherein the frame is substantially rigid.

52. A method for thermal compensation of an optical waveguide grating comprises:
securing an optical waveguide equipped with an optical grating at two attachment points of a thermal compensation package; and
varying the distance between the attachment points non-linearly with temperature over an operating temperature range.

53. The method of claim 52, wherein varying the distance non-linearly with temperature over an operating temperature range comprises varying the distance linearly within each of a plurality of temperature ranges within the operating temperature range.
